(19) United States
(12) Patent Application Publication
(10) Pub. No.: US 2024/0075838 A1
(43) Pub. Date: Mar. 7, 2024

(54) Method, System, and Computer Program Product for Charging an Electric Vehicle Using Ultra-Capacitors

(71) Applicant: Velocity Magnetics, Inc., New Castle, PA (US)

(72) Inventors: Domenic P. Marzano, New Castle, PA (US); Alex R. Rugh, New Castle, PA (US); Joseph L. Hake, New Castle, PA (US)

(21) Appl. No.: 18/269,069

(22) PCT Filed: Dec. 22, 2021
(86) PCT No.: PCT/US21/64779

§ 371 Date: Jun. 22, 2023

Related U.S. Application Data
(60) Provisional application No. 63/130,325, filed on Dec. 23, 2020.
(60) Provisional application No. 63/137,413, filed on Jan. 14, 2021.
(60) Provisional application No. 63/148,757, filed on Feb. 12, 2021.

(51) Int. Cl. B60L 53/55; B60L 53/122; H02J 7/34

(52) U.S. Cl. CPC B60L 53/55; B60L 53/122; H02J 7/345; H02J 50/10

(57) ABSTRACT

Provided is a system for charging an electric vehicle using ultra-capacitors. The system may include an input to receive power from a power source. An ultra-capacitor charger may be connected to the input and may receive power from the input. The ultra-capacitor charger may be connected to an array of ultra-capacitors and may supply power to control charging and discharging of the array of ultra-capacitors. An output may be connected to the array of ultra-capacitors. The output may include a current controller, a voltage controller, any combination thereof, and/or the like configured to supply power to at least one battery. A method and computer program product are also disclosed.

### CROSS REFERENCE TO RELATED APPLICATIONS

The present application claims the benefit of U.S. Provisional Patent Application Nos. 63/130,325, filed Dec. 23, 2020, 63/137,413, filed Jan. 14, 2021, and 63/148,757, filed Feb. 12, 2021, the disclosures of which are hereby incorporated by reference in their entireties.

### BACKGROUND

### 1. Field

This disclosed subject matter relates generally to methods, systems, and products for charging batteries and, in some particular embodiments, to a method, system, and computer program product for charging an electric vehicle using ultra-capacitors.

### 2. Technical Considerations

Certain electric vehicles are powered by batteries. Such batteries may be charged by chargers with different power levels. For example, a Level 1 charger may use power with a voltage up to 120 V (e.g., 110 V, 120 V, and/or the like) as input (e.g., from a typical residential power outlet) and/or may output power to the battery with a current of 12-16 A (e.g., up to about 2 kW of power). A Level 2 charger may use power with a voltage up to 240 V (e.g., 208 V, 240 V, and/or the like) as input and/or may output power to the battery with a current of 16-40 A (e.g., up to about 9.6 kW of power). A Level 3 charger (e.g., direct current (DC) fast charger and/or the like) may use power with a voltage up to 480 V, a voltage of greater than 480 V, and/or the like and/or may output power to the battery with a current of up to 100 A, greater than 100 A, and/or the like (e.g., up to 50-60 kW of power). The batteries of certain electric vehicles may be capable of charging from Level 1 chargers, Level 2 chargers, and/or Level 3 chargers. Indeed, certain batteries may even be capable of charging with greater current and/or power than Level 3 chargers. For example, a 40 kWh battery may be rated to charge with up to 120 kW of power.

However, a specialized outlet may be required to use a Level 2 charger, since a typical power outlet may only provide power with a voltage up to 120 V. Additionally, a Level 3 charger may not be available to use in a residential setting since power outlets with 480 V and/or 100 A may be unavailable. Even in a commercial setting, a specialized outlet may be required to achieve 480 V and/or 100 A. In such a commercial setting, if multiple outlets are desired (e.g., a charging station with multiple ports and/or the like), a connection to the power grid with hundreds or even thousands of amps (A) may be required. However, such connections may be very expensive and/or may not be available in all areas, depending on the capacity of the grid. In any of the aforementioned settings, it may be wasteful to install such specialized outlets and/or such specialized connections to the power grid since the full capacity thereof may not be utilized at all times (e.g., only utilized when charging, and otherwise not being utilized at all). Even if such specialized outlets are installed, the batteries may be capable of charging with greater power than even may be provided by the corresponding chargers.

Moreover, in remote areas (e.g., along certain highways, unpopulated areas, large parks, nature reserves, and/or the like), a connection to the power grid may be completely unavailable. Additionally or alternatively, even if a low voltage (e.g., 120 V) connection to the power grid or another power source (e.g., solar panel array, generator, and/or the like) may be available, a higher voltage (e.g., 240 V, 480 V, or more) connection may be unavailable.

### SUMMARY

Accordingly, it is an object of the presently disclosed subject matter to provide methods, systems, and computer program products for charging batteries (e.g., of an electric vehicle) using ultra-capacitors that overcome some or all of the deficiencies identified above.

According to non-limiting embodiments, provided is a system for charging batteries (e.g., of an electric vehicle) using ultra-capacitors. In some non-limiting embodiments, a system may include an input configured to receive power from a power source; an array of ultra-capacitors; an ultra-capacitor charger connected to the input and configured to receive power from the input, the ultra-capacitor charger connected to the array of ultra-capacitors and configured to supply power to control charging and discharging of the array of ultra-capacitors; and an output connected to the array of ultra-capacitors, the output including at least one of a current controller, a voltage controller, or any combination thereof configured to supply power to at least one battery.

In some non-limiting embodiments, the system may further include a direct current (DC) bus. The array of ultra-capacitors may be connected to the DC bus. The ultra-capacitor charger may be connected to the DC bus and configured to supply power to the DC bus to control the charging and discharging of the array of ultra-capacitors. The output may be connected to the DC bus and configured to receive power from the DC bus.

In some non-limiting embodiments, the system may further include a controller. The controller may be configured to control the ultra-capacitor charger to control charging and discharging of the array of ultra-capacitors. The controller may be configured to control the at least one of the current controller, the voltage controller, or any combination thereof to supply power to the at least one battery.

In some non-limiting embodiments, the output may further include a voltage converter. The voltage converter may be configured to receive power having a first voltage from the array of ultra-capacitors and to supply power having a second voltage to the at least one battery.

In some non-limiting embodiments, the power source may include at least one of a power grid, a solar panel, a windmill, a power plant, a thermoelectric device, a generator, or any combination thereof.

In some non-limiting embodiments, the current controller may be configured to receive power having a first current from the array of ultra-capacitors and to supply power having a second current to the at least one battery, wherein the second current is less than or equal to a current rating of the at least one battery.

In some non-limiting embodiments, the power source may include at least one of a DC power source, an alternating current (AC) power source, a single-phase AC power source, a three-phase AC power source, a multi-phase AC power source, or any combination thereof.

In some non-limiting embodiments, the output may be configured to supply at least one of DC power, AC power, single-phase AC power, three-phase AC power source, multi-phase AC power, or any combination thereof to the battery.

In some non-limiting embodiments, the system may further include an inductive charger including at least one first induction coil connected to the output and at least one second induction coil connected to the battery. The output may be configured to supply power via the inductive charger to the at least one battery.

According to non-limiting embodiments, provided is a method for charging batteries (e.g., of an electric vehicle) using ultra-capacitors. In some non-limiting embodiments, a method may include receiving power at an input from a power source, supplying power from the input to an ultra-capacitor charger, supplying power from the ultra-capacitor charger to an array of ultra-capacitors to control charging and discharging of the array of ultra-capacitors, supplying power from the array of ultra-capacitors to an output including at least one of a current controller, a voltage controller, or any combination thereof, and supplying power from the output to at least one battery.

In some non-limiting embodiments, a DC bus may be connected to the ultra-capacitor charger, the array of ultra-capacitors, and the output. Supplying power from the ultra-capacitor charger to the array of ultra-capacitors may include supplying power from the ultra-capacitor charger to the DC bus to control the charging and discharging of the array of ultra-capacitors. Supplying power from the array of ultra-capacitors to the output may include supplying power from the array of ultra-capacitors to the DC bus to supply power to the output.

In some non-limiting embodiments, the output may include a voltage converter. Supplying power from the output to the at least one battery may include receiving, by the voltage converter, power having a first voltage from the array of ultra-capacitors, and/or supplying, by the voltage converter, power having a second voltage to the at least one battery.

In some non-limiting embodiments, supplying power from the output to the at least one battery may include receiving, by the current controller, power having a first current from the array of ultra-capacitors, and/or supplying, by the current controller, power having a second current to the at least one battery, wherein the second current is less than or equal to a current rating of the at least one battery.

In some non-limiting embodiments, the output may includes at least one first induction coil. The battery may be connected to at least one second induction coil. Supplying power from the output to the at least one battery may include supplying power via the at least one first induction coil to the at least one second induction coil to supply power to the at least one battery.

According to non-limiting embodiments, provided is a computer program product for charging batteries (e.g., of an electric vehicle) using ultra-capacitors. In some non-limiting embodiments, a computer program product may include at least one non-transitory computer-readable medium including one or more instructions that, when executed by at least one processor, cause the at least one processor to control an ultra-capacitor charger to receive power from an input connected to a power source and to supply power to control charging and discharging of an array of ultra-capacitors connected to the ultra-capacitor charger, and control at least one of a current controller, a voltage controller, or any combination thereof to receive power from the array of ultra-capacitors and to supply power via an output to at least one battery.

In some non-limiting embodiments, a DC bus may be connected to the ultra-capacitor charger, the array of ultra-capacitors, and the output. Controlling the ultra-capacitor charger may include controlling the ultra-capacitor charger to supply power to the DC bus to control the charging and discharging of the array of ultra-capacitors. Controlling the at least one of the current controller, the voltage controller, or any combination thereof may include controlling the at least one of the current controller, the voltage controller, or any combination thereof to receive power from the array of ultra-capacitors via the DC bus.

In some non-limiting embodiments, the output may further include a voltage converter. Supplying power via the output to the at least one battery may include controlling the voltage converter to: receive power having a first voltage from the array of ultra-capacitors, and/or supply power having a second voltage to the at least one battery.

In some non-limiting embodiments, controlling the current controller may include controlling the current controller to: receive power having a first current from the array of ultra-capacitors, and/or supply power having a second current to the at least one battery, wherein the second current is less than or equal to a current rating of the at least one battery.

In some non-limiting embodiments, the output may include at least one first induction coil. The battery may be connected to at least one second induction coil. Supplying power via the output to the at least one battery may include supplying power via the at least one first induction coil to the at least one second induction coil to supply power to the at least one battery.

Further embodiments or aspects are set forth in the following numbered clauses:

Clause 1: A system, comprising: an input configured to receive power from a power source; an array of ultra-capacitors; an ultra-capacitor charger connected to the input and configured to receive power from the input, the ultra-capacitor charger connected to the array of ultra-capacitors and configured to supply power to control charging and discharging of the array of ultra-capacitors; and an output connected to the array of ultra-capacitors, the output comprising at least one of a current controller, a voltage controller, or any combination thereof configured to supply power to at least one battery.

Clause 2: The system of clause 1, further comprising a direct current (DC) bus, wherein the array of ultra-capacitors is connected to the DC bus; wherein the ultra-capacitor charger is connected to the DC bus and configured to supply power to the DC bus to control the charging and discharging of the array of ultra-capacitors; and wherein the output is connected to the DC bus and configured to receive power from the DC bus.

Clause 3: The system of any preceding clause, further comprising a controller, wherein the controller is configured to control the ultra-capacitor charger to control charging and discharging of the array of ultra-capacitors, and wherein the controller is configured to control the at least one of the current controller, the voltage controller, or any combination thereof to supply power to the at least one battery.

Clause 4: The system of any preceding clause, wherein the output further comprises a voltage converter, wherein the voltage converter is configured to receive power having a first voltage from the array of ultra-capacitors and to supply power having a second voltage to the at least one battery.

Clause 5: The system of any preceding clause, wherein the power source comprises at least one of a power grid, a solar panel, a windmill, a power plant, a thermoelectric device, a generator, or any combination thereof.

Clause 6: The system of any preceding clause, wherein the current controller is configured to receive power having a first current from the array of ultra-capacitors and to supply power having a second current to the at least one battery, wherein the second current is less than or equal to a current rating of the at least one battery.

Clause 7: The system of any preceding clause, wherein the power source comprises at least one of a direct current (DC) power source, an alternating current (AC) power source, a single-phase AC power source, a three-phase AC power source, a multi-phase AC power source, or any combination thereof.

Clause 8: The system of any preceding clause, wherein the output is configured to supply at least one of direct current (DC) power, alternating current (AC) power, single-phase AC power, three-phase AC power source, multi-phase AC power, or any combination thereof to the battery.

Clause 9: The system of any preceding clause, further comprising an inductive charger comprising at least one first induction coil connected to the output and at least one second induction coil connected to the battery, wherein the output is configured to supply power via the inductive charger to the at least one battery.

Clause 10: A method, comprising: receiving power at an input from a power source; supplying power from the input to an ultra-capacitor charger; supplying power from the ultra-capacitor charger to an array of ultra-capacitors to control charging and discharging of the array of ultra-capacitors; supplying power from the array of ultra-capacitors to an output comprising at least one of a current controller, a voltage controller, or any combination thereof; and supplying power from the output to at least one battery.

Clause 11: The method of clause 10, wherein a direct current (DC) bus is connected to the ultra-capacitor charger, the array of ultra-capacitors, and the output, wherein supplying power from the ultra-capacitor charger to the array of ultra-capacitors comprises supplying power from the ultra-capacitor charger to the DC bus to control the charging and discharging of the array of ultra-capacitors, and wherein supplying power from the array of ultra-capacitors to the output comprises supplying power from the array of ultra-capacitors to the DC bus to supply power to the output.

Clause 12. The method of clause 10 or 11, wherein the output further comprises a voltage converter, and wherein supplying power from the output to the at least one battery comprises: receiving, by the voltage converter, power having a first voltage from the array of ultra-capacitors; and supplying, by the voltage converter, power having a second voltage to the at least one battery.

Clause 13: The method of any one of clauses 10-12, wherein supplying power from the output to the at least one battery comprises: receiving, by the current controller, power having a first current from the array of ultra-capacitors; and supplying, by the current controller, power having a second current to the at least one battery, wherein the second current is less than or equal to a current rating of the at least one battery.

Clause 14: The method of any one of clauses 10-13, wherein the output comprises at least one first induction coil, wherein the battery is connected to at least one second induction coil, and wherein supplying power from the output to the at least one battery comprises supplying power via the at least one first induction coil to the at least one second induction coil to supply power to the at least one battery.

Clause 15: A computer program product comprising at least one non-transitory computer-readable medium including one or more instructions that, when executed by at least one processor, cause the at least one processor to: control an ultra-capacitor charger to receive power from an input connected to a power source and to supply power to control charging and discharging of an array of ultra-capacitors connected to the ultra-capacitor charger; and control at least one of a current controller, a voltage controller, or any combination thereof to receive power from the array of ultra-capacitors and to supply power via an output to at least one battery.

Clause 16: The computer program product of clause 15, wherein a direct current (DC) bus is connected to the ultra-capacitor charger, the array of ultra-capacitors, and the output, wherein controlling the ultra-capacitor charger comprises controlling the ultra-capacitor charger to supply power to the DC bus to control the charging and discharging of the array of ultra-capacitors, and wherein controlling the at least one of the current controller, the voltage controller, or any combination thereof comprises controlling the at least one of the current controller, the voltage controller, or any combination thereof to receive power from the array of ultra-capacitors via the DC bus.

Clause 17: The computer program product of clause 15 or 16, wherein the output further comprises a voltage converter, and wherein supplying power via the output to the at least one battery comprises controlling the voltage converter to: receive power having a first voltage from the array of ultra-capacitors; and supply power having a second voltage to the at least one battery.

Clause 18: The computer program product of any one of clauses 15-17, wherein controlling the current controller comprises controlling the current controller to: receive power having a first current from the array of ultra-capacitors; and supply power having a second current to the at least one battery, wherein the second current is less than or equal to a current rating of the at least one battery.

Clause 19: The computer program product of any one of clauses 15-18, wherein the output comprises at least one first induction coil, wherein the battery is connected to at least one second induction coil, and wherein supplying power via the output to the at least one battery comprises supplying power via the at least one first induction coil to the at least one second induction coil to supply power to the at least one battery.

These and other features and characteristics of the presently disclosed subject matter, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter. As used in the specification and the claims, the singular form of “a,” “an,” and “the” include plural referents unless the context clearly dictates otherwise.

### BRIEF DESCRIPTION OF THE DRAWINGS

Additional advantages and details of the disclosed subject matter are explained in greater detail below with reference to the exemplary embodiments that are illustrated in the accompanying figures, in which:

FIGS. 1A-1C are diagrams of a non-limiting embodiment of an environment in which methods, systems, and/or computer program products, as described herein, may be implemented according to the principles of the presently disclosed subject matter;

FIG. 2 is a diagram of a non-limiting embodiment of components of one or more devices of FIGS. 1A-1C;

FIG. 3 is a flowchart of a non-limiting embodiment of a process for uninterrupted power using an array of ultra-capacitors according to the principles of the presently disclosed subject matter; and

FIG. 4 is a diagram of a non-limiting embodiment of an implementation of a non-limiting embodiment of the process shown in FIG. 3 according to the principles of the presently disclosed subject matter.

### DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the disclosed subject matter as it is oriented in the drawing figures. However, it is to be understood that the disclosed subject matter may assume various alternative variations and step sequences, except where expressly specified to the contrary. It is also to be understood that the specific devices and processes illustrated in the attached drawings, and described in the following specification, are simply exemplary embodiments or aspects of the disclosed subject matter. Hence, specific dimensions and other physical characteristics related to the embodiments or aspects disclosed herein are not to be considered as limiting unless otherwise indicated.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

As used herein, the terms “communication” and “communicate” may refer to the reception, receipt, transmission, transfer, provision, and/or the like of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and communicates the processed information to the second unit. In some non-limiting embodiments, a message may refer to a network packet (e.g., a data packet and/or the like) that includes data. It will be appreciated that numerous other arrangements are possible.

As used herein, the term “controller” may refer to one or more computing devices or combinations of computing devices (e.g., processors, servers, devices, software applications, components of such, and/or the like). Reference to “a controller,” “a processor,” and/or the like, as used herein, may refer to a previously-recited controller or processor that is recited as performing a previous step or function, a different controller or processor, and/or a combination of controllers and/or processors. For example, as used in the specification and the claims, a first controller or a first processor that is recited as performing a first step or a first function may refer to the same or different controller or the same or different processor recited as performing a second step or a second function.

Non-limiting embodiments of the disclosed subject matter are directed to systems, methods, and computer program products for charging batteries, including, but not limited to, charging an electric vehicle using an array of ultra-capacitors. For example, non-limiting embodiments of the disclosed subject matter provide an ultra-capacitor charger configured to receive power from an input connected to a power source and to supply power to control charging and discharging of an array of ultra-capacitors connected to the ultra-capacitor charger and a current controller connected to the array of ultra-capacitors and configured to supply power to at least one battery via an output. Such embodiments provide techniques and systems that allow the array of ultra-capacitors to charge over time (e.g., slowly, when no battery is connected to be charged, and/or the like) from available power sources, even if such power sources are relatively low power (e.g., low voltage, low current, and/or the like), and that allow the array of ultra-capacitors to discharge rapidly (e.g., faster than such ultra-capacitors were charged) when a battery is connected for charging. Additionally or alternatively, such embodiments provide techniques and systems that enable charging of the battery at fast speeds and/or high power (e.g., power of a Level 2 charger, power of a Level 3 charger, maximum power rating of the battery, and/or the like) even when the available power source has a voltage and/or current capacity less than would be needed to otherwise achieve such speeds and/or high power. Additionally or alternatively, such embodiments provide techniques and systems that enable charging of the battery at fast speeds and/or high power without a specialized outlet (e.g., using a typical residential power outlet having power up to 120 V). Additionally or alternatively, such embodiments provide techniques and systems that enable charging of multiple batteries at fast speeds and/or high power via multiple outlets (e.g., in a commercial setting) without a special high-current (e.g., hundreds or thousands of amps) connection to a power grid. Additionally or alternatively, such embodiments provide techniques and systems that enable charging of the battery in remote areas (e.g., along certain highways, unpopulated areas, large parks, nature reserves, and/or the like) where a connection to the power grid may be unavailable, but other power sources (e.g., solar panel array, generator, and/or the like) may be available. Additionally or alternatively, such embodiments provide techniques and systems that provide a supplement to an existing charger, e.g., by boosting the power of a relatively low power charger (e.g., a Level 1 charger with 120 V input and/or the like) until the energy stored in the ultra-capacitors is depleted, then allowing the low power charger to finish charging the battery at a lower power rate until the battery is fully charged. Additionally or alternatively, such embodiments provide techniques and systems that may handle all types of power input (e.g., receive power from all types of power sources) and/or convert power from any type of power source to power usable to charge a battery. Additionally or alternatively, such embodiments provide techniques and systems that enable receiving power from a relatively low power source (e.g., residential/120 V power grid, solar panel array, and/or the like) and storing energy until needed to charge a battery (e.g., of an electric vehicle). Additionally or alternatively, such embodiments provide techniques and systems that enable spreading out the demand for power by charging the ultra-capacitors over time (e.g., slowly at a predetermined rate) and/or releasing the energy stored in the ultra-capacitors quickly when charging a battery (e.g., of an electric vehicle). Additionally or alternatively, such embodiments provide techniques and systems that enable reducing the demand (e.g., current demands, power demands, and/or the like) for charging a battery by supplementing the current from the power source. Additionally or alternatively, such embodiments provide techniques and systems that enable supplying any suitable type of power from the output (e.g., current controller thereof and/or the like) to the battery for charging, including but not limited to direct current (DC) power, alternating current (AC) power (e.g., single-phase AC power, three phase AC power, and/or the like), and/or the like.

For the purpose of illustration, in the following description, while the presently disclosed subject matter is described with respect to methods, systems, and computer program products for charging a battery using an array of ultra-capacitors, e.g., for an electric vehicle, one skilled in the art will recognize that the disclosed subject matter is not limited to the illustrative embodiments. For example, the methods, systems, and computer program products described herein may be used with a wide variety of settings, such as charging batteries in any setting suitable for using such batteries, e.g., high capacity batteries for energy storage/management and/or the like.

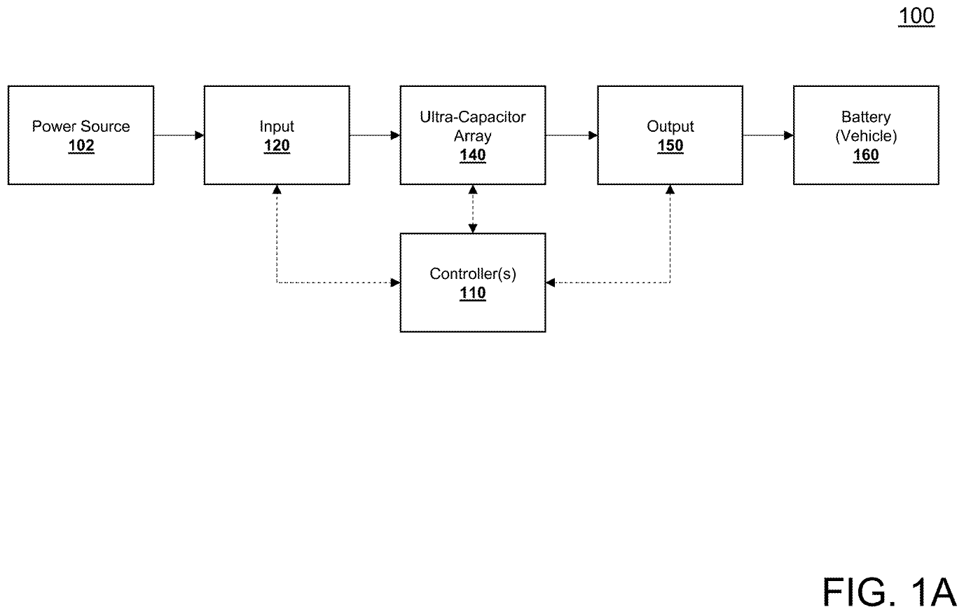

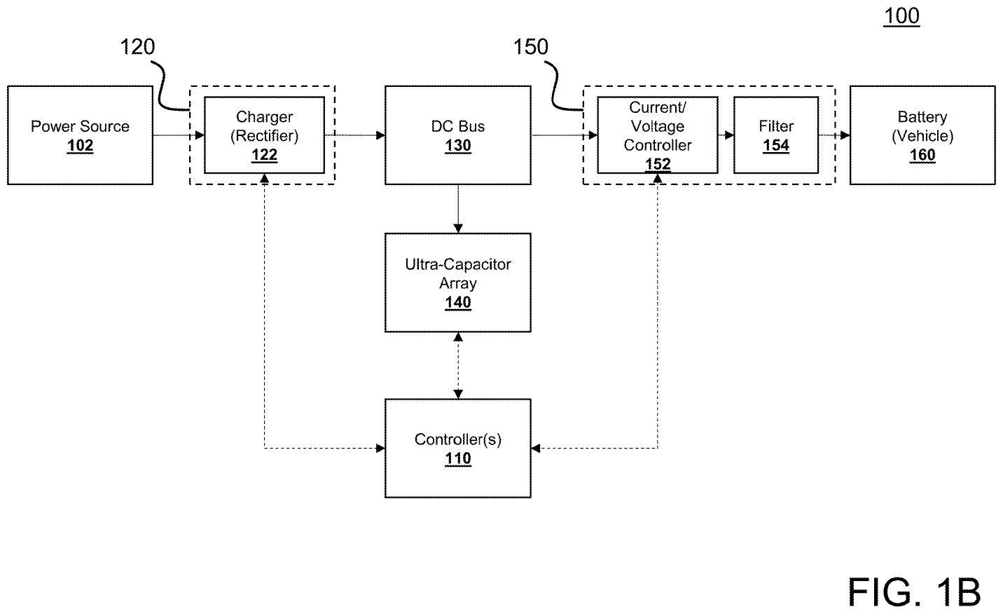

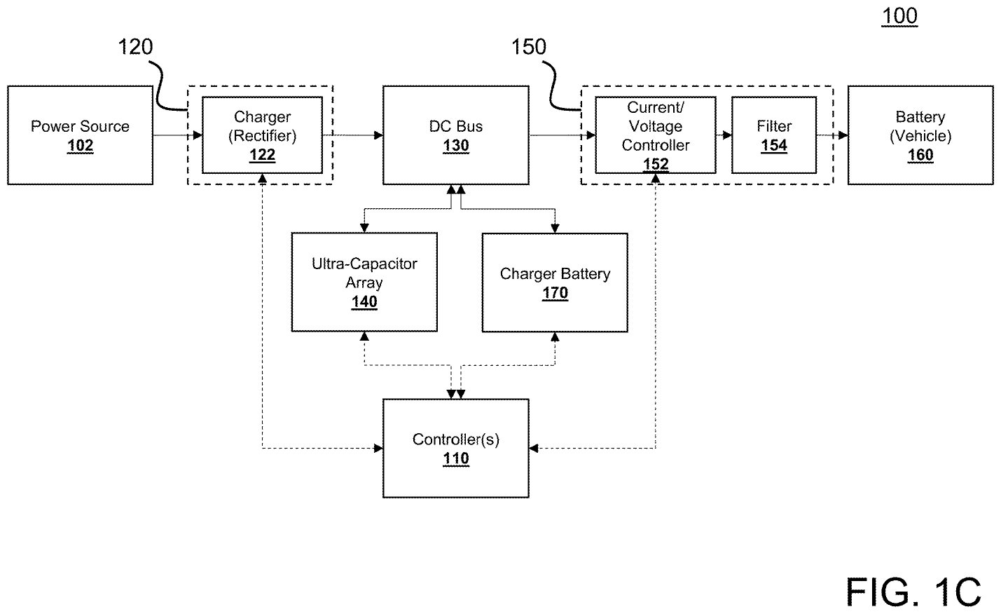

Referring now to FIGS. 1A-1C, FIGS. 1A-1C are diagrams of a non-limiting embodiment of an environment 100 in which systems, products, and/or methods, as described herein, may be implemented. As shown in FIGS. 1A-1C, environment 100 may include power source 102, controller 110, input 120, charger 122, DC bus 130, ultra-capacitor array 140, output 150, current/voltage controller 152, battery 160, charger battery 170, and/or the like.

Power source 102 may include any suitable power source. For example, power source 102 may include a connection to a power grid (e.g., public power grid, municipal power grid, utility power grid, three-phase (e.g., industrial and/or the like) power grid, single phase (e.g., residential and/or the like) power grid, and/or the like). Additionally or alternatively, power source 102 may include at least one solar panel (e.g., an array of solar panels), at least one windmill, a power plant (e.g., coal power plant, natural gas power plant, gasoline power plant, diesel power plant, nuclear power plant, any combination thereof, and/or the like), at least one thermoelectric device, a generator (e.g., diesel generator, gasoline generator, and/or the like), any combination thereof, and/or the like. In some non-limiting embodiments, power source 102 may include an AC power supply. Additionally or alternatively, power source 102 may include a DC power supply. In some non-limiting embodiments, power source 102 may be connected (e.g., electrically connected, coupled, and/or the like) to input 120 and/or the like. In some non-limiting embodiments, the potential (e.g., voltage (V)), current (e.g., amperes (A)), and/or power (e.g., watts (W)) of power source 102 may be selected (e.g., predetermined, preselected, dynamically selected, and/or the like) based on the power demands of the system (e.g., battery 160, DC bus 130, ultra-capacitor array 140, and/or the like), based on availability (e.g., in the area of the system and/or the like), and/or the like. For example, power source 102 may have a potential of 120 volts AC (VAC) (e.g., determined based on root mean squared (RMS) voltage and/or the like), 240 VAC, 480 VAC, 690 VAC, and/or the like.

Controller 110 may include one or more devices capable of receiving information from, communicating information to, and/or controlling input 120, charger 122, ultra-capacitor array 140, output 150, current/voltage controller 152, any combination thereof, and/or the like. In some non-limiting embodiments, controller 110 may be implemented in hardware, software, firmware, and/or any combination thereof. For example, controller 110 may include a computing device, such as a processor (e.g., a central processing unit (CPU), a graphics processing unit (GPU), an accelerated processing unit (APU), and/or the like), a microprocessor, a digital signal processor (DSP), a processing component (e.g., a field-programmable gate array (FPGA), an application-specific integrated circuit (ASIC), a programmable logic controller (PLC), and/or the like), a group of computing devices, other like devices, any combination thereof, and/or the like, which can be programmed to perform a function. In some non-limiting embodiments, controller 110 may include a cabinet including at least one processing component (e.g., PLC and/or the like), a human-machine interface (HMI), and/or the like. In some non-limiting embodiments, controller 110 may be in communication with a data storage device, which may be local or remote to controller 110. In some non-limiting embodiments, controller 110 may be capable of receiving information from, storing information in, communicating information to, and/or searching information stored in the data storage device. In some non-limiting embodiments, each of charger 122 and/or current/voltage controller 152 may include a controller 110 (e.g., charger 122 may include a first controller 110 to control charger 122 and/or current/voltage controller 152 may include a second controller 110 to control current/voltage controller 152).

In some non-limiting embodiments, controller 110 may include an HMI (e.g., including at least one of input component 210, output component 212, any combination thereof, and/or the like, as described herein). For example, the HMI may include a touch screen display (e.g., which may serve as both input component 210 and output component 212, as described herein). In some non-limiting embodiments, the HMI may enable a user to input (e.g., select from a menu or list, type, and/or the like) a make, a model, a year (e.g., model year), and/or the like of an electric vehicle. In response to these inputs, controller 110 may determine (e.g., select, calculate, and/or the like) at least one of a rated power (e.g., maximum rated power, a rated power range, and/or the like), a rated current (e.g., a maximum rated current, a rated current range, and/or the like), a rated voltage (e.g., maximum rated voltage, a rated voltage range, and/or the like), any combination thereof, and/or the like of the electric vehicle and/or the battery thereof (e.g., based on the inputs). Additionally or alternatively (e.g., in response to that determination), controller 110 may set (e.g., adjust and/or the like) at least one of the power, the voltage, the current, any combination thereof, and/or the like that output 150 will supply to the electric vehicle and/or battery 160 thereof (e.g., based on the determination of the rated power, rated current, rated voltage, and/or the like). In some non-limiting embodiments, the HMI may enable a user to input (e.g., select from a menu or list, type, and/or the like) at least one of a desired power (or desired power range), a desired current (or desired current range), a desired voltage (or desired voltage range), any combination thereof, and/or the like. Additionally or alternatively (e.g., in response to those inputs), controller 110 may set (e.g., adjust and/or the like) at least one of the power, the voltage, the current, any combination thereof, and/or the like that output 150 will supply to the electric vehicle and/or battery 160 thereof (e.g., based on the desired power, desired current, desired voltage, and/or the like).

Input 120 may include at least one electronic component, at least one circuit, any combination thereof, and/or the like. In some non-limiting embodiments, input 120 may be connected (e.g., electrically connected, coupled, and/or the like) to power source 102. Additionally or alternatively, input 120 may be connected (e.g., electrically connected, coupled, and/or the like) to charger 122 and/or DC bus 130. In some non-limiting embodiments, input 120 may be configured to receive power from power source 102. Additionally or alternatively, input 120 may be configured to supply power to DC bus 130 (e.g., directly, indirectly via charger 122, and/or the like). In some non-limiting embodiments, input 120 may include charger 122. Additionally or alternatively, input 120 may be connected to charger 122.

Charger 122 may include at least one electronic component, at least one circuit, any combination thereof, and/or the like. Additionally or alternatively, charger 122 may include at least one controller (e.g., controller 110 and/or the like). In some non-limiting embodiments, charger 122 may include an ultra-capacitor charger. In some non-limiting embodiments, charger 122 may be connected to input 120 and/or configured to receive power from input 120. Additionally or alternatively, charger 122 may be connected to ultra-capacitor array 140 and/or configured to supply power to control charging and discharging of ultra-capacitor array 140.

In some non-limiting embodiments, input 120 and/or charger 122 may be configured to convert power. For example, if power source 102 is an AC power supply, input 120 and/or charger 122 may convert power from AC to DC (e.g., using an AC-to-DC converter, a rectifier, and/or the like). Additionally or alternatively, input 120 and/or charger 122 may be configured to convert power from a first potential (e.g., first voltage) to a second potential (e.g., second voltage). For example, the second potential (e.g., voltage) may be higher than the first potential (e.g., voltage). In some non-limiting embodiments, the second potential may be selected (e.g., predetermined, preselected, dynamically selected, and/or the like) based on the power demands of the system (e.g., battery 160, DC bus 130, ultra-capacitor array 140, and/or the like) and/or the like. Additionally or alternatively, the second potential may be selected to meet and/or exceed a desired charging level of battery 160 (e.g., voltage of a Level 2 charger, voltage of a Level 3 charger, maximum voltage rating of the battery, and/or the like). Additionally or alternatively, the second potential may be selected to meet and/or exceed a ratio based on the desired potential of DC bus 130 (e.g., the ratio of the potential of the DC bus 130 in volts DC (VDC) to the second potential in VAC may be less than or equal to 1.414 (e.g., the square root of 2), 1.3, 1.25, 1.231, 1.2, 1.15, 1.143, and/or the like).

In some non-limiting embodiments, if power source 102 is an AC power supply, input 120 and/or charger 122 may include at least one transformer (e.g., a step-up transformer, a step-down transformer, any combination thereof, and/or the like). Additionally or alternatively, input 120 and/or charger 122 may include at least one of a boost converter, a buck converter, a buck-boost converter, any combination thereof, and/or the like. In some non-limiting embodiments input 120 and/or charger 122 may include at least one of a filter (e.g., a radio frequency interference (RFI) filter and/or the like), a fuse, an inductor, any combination thereof, and/or the like.

In some non-limiting embodiments, controller 110 and/or charger 122 may be configured to control charging and discharging of ultra-capacitor array 140. For example, controller 110 and/or charger 122 may detect when battery 160 is not connected to output 150 and/or may control charger 122 to charge ultra-capacitor array 140. Additionally or alternatively, controller 110 and/or charger 122 may detect when battery 160 is connected to output 150 and/or may control charger 122 to discharge ultra-capacitor array 140 to thereby charger battery 160. In some non-limiting embodiments, controller 110 and/or charger 122 may control charger 122 to continuously supply power to ultra-capacitor array 140 while power source 102 is connected to input 120 (e.g., whether battery 160 is connected to output 150 or not).

In some non-limiting embodiments, input 120 and/or charger 122 may include at least one switching element. For example, the switching element may include at least one rectifier (e.g., to convert AC power to DC power). For example, the at least one rectifier may include at least one silicon controlled rectifier (SCR), at least one insulated-gate bipolar transistor (IGBT) rectifier, any combination thereof, and/or the like. Additionally or alternatively, the switching element may include at least one switch (e.g., silicon controlled switch (SCS), a transistor switch, a metal-oxide-semiconductor field-effect transistor (MOSFET) switch, an IGBT switch, any combination thereof, and/or the like). In some non-limiting embodiments, controller 110 and/or charger 122 may control the switching element (e.g., directly, indirectly via a control board, any combination thereof, and/or the like), e.g., to control charging and/or discharging of ultra-capacitor array 140 connected to the DC bus 130 (e.g., to supply power from DC bus 130 to output 150).

In some non-limiting embodiments, input 120 and/or charger 122 may be as described in U.S. Provisional Patent Application Nos. 62/978,999, filed Feb. 20, 2020, 63/107,826, filed Oct. 30, 2020, and 63/127,948, filed Dec. 18, 2020, the disclosures of which are hereby incorporated by reference herein in their entireties.

DC bus 130 may include any suitable high voltage bus. For example, DC bus 130 may include a busbar, a copper bar, a metallic bar, a conductive bar, a wide and/or thick conductor, any combination thereof, and/or the like. In some non-limiting embodiments, DC bus 130 may have relatively low resistance for DC power. Additionally or alternatively, DC bus 130 may be configured to operate in a range of voltages. For example, DC bus 130 may be configured to operate at voltages of 100-3,000 V, up to 120 V, up to 240 V, up to 480 V, over 480 V, over 575 V, over 650 V, over 690 V, over 700 V, over 750 V, any combination thereof, and/or the like. In some non-limiting embodiments, DC bus 130 may be connected (e.g., electrically connected, coupled, and/or the like) to input 120, ultra-capacitor array 140, output 150, any combination thereof, and/or the like. In some non-limiting embodiments, the potential (e.g., voltage) of DC bus 130 may be selected (e.g., predetermined, preselected, dynamically selected, and/or the like) based on the power demands of the system (e.g., battery 160, ultra-capacitor array 140, output 150 (e.g., current/voltage controller 152 thereof), and/or the like) and/or the like). Additionally or alternatively, the potential of DC bus 130 may be selected to meet and/or exceed a ratio based on the desired potential of output 150 (e.g., current/voltage controller 152 thereof), e.g., the ratio of the potential of the DC bus 130 in VDC to the potential of output 150 (e.g., current/voltage controller 152 thereof) in VDC may be less than or equal to 1. Additionally or alternatively, the ratio may be less than or equal to 3, 2, 1.414 (e.g., the square root of 2), 1.3, 1.25, 1.231, 1.2, 1.15, 1.143, and/or the like. For example, the potential of DC bus 130 may be less than or equal to 480 VDC (e.g., 470-480 VDC, 240-480 VDC, and/or the like), 800 VDC (e.g. a range of 790-800 VDC, 650-800 VDC, 600-800 VDC, and/or the like), less than or equal to 1200 VDC (e.g., a range of 1190-1200 VDC, 650-1200 VDC, and/or the like), and/or the like.

Ultra-capacitor array 140 may include a plurality of ultra-capacitors. In some non-limiting embodiments, ultra-capacitor array 140 may be connected (e.g., electrically connected, coupled, and/or the like) to DC bus 130 and/or like. In some non-limiting embodiments, ultra-capacitor array 140 may include a number of ultra-capacitors selected based on the energy needs (e.g., power demands and/or the like) of the system. Additionally or alternatively, ultra-capacitors (of ultra-capacitor array 140) may be provided in modules (e.g., subsets) corresponding to a fixed unit of energy storage representing a maximum suggested energy storage amount of the ultra-capacitors in the module. In some non-limiting embodiments, at least some ultra-capacitors (and/or modules thereof) may be connected in series, e.g., such that the combined (e.g., summed and/or the like) voltage of the series-connected ultra-capacitors satisfies (e.g., equals, exceeds, and/or the like) the desired operating voltages of DC bus 130, output 150, and/or the like. Additionally or alternatively, at least some ultra-capacitors (and/or modules thereof) may be connected in parallel, e.g., such that the combined (e.g., summed and/or the like) current of the parallel-connected ultra-capacitors satisfies (e.g., equals, exceeds, and/or the like) the desired current of the system (e.g., output 150, battery 160, and/or the like). For example, ultra-capacitor array 140 may include a plurality of modules, each module including a plurality of ultra-capacitors in series to combine to provide the desired operating voltage of DC bus 130 and/or output 150, and the modules may be connected in parallel with each other to provide the desired current of the system (e.g., output 150, battery 160, and/or the like). In some non-limiting embodiments, the capacitance (e.g., farads (F)) of ultra-capacitor array 140 may be selected (e.g., predetermined, preselected, dynamically selected, and/or the like) based on the power demands of the system (e.g., battery 160, DC bus 130, output 150 (e.g., current/voltage controller 152 thereof), and/or the like) and/or the like. Additionally or alternatively, the capacitance (e.g., farads (F)) of ultra-capacitor array 140 may be selected to meet and/or exceed a ratio based on the desired potential, power, and/or the like of DC bus 130. For example, the capacitance of ultra-capacitor array 140 may be 13.88 F, 30 F, 60 F, and/or the like. In some non-limiting embodiments, the capacitance of ultra-capacitor array 140 may be selected to provide sufficient power to battery 160 for a selected period of time. For example, the capacitance of ultra-capacitor array 140 may be selected to ensure that ultra-capacitor array 140 can provide sufficient power for battery 160 to fully charge within a desired time period (e.g., charge at the power of a Level 2 charger, a Level 3 charger, a maximum power rating of battery 160, and/or the like for sufficient time to fully charge battery 160). Additionally or alternatively, the capacitance of ultra-capacitor array 140 may be selected to ensure that ultra-capacitor array 140 can provide sufficient power for battery 160 to charge enough to power an electric vehicle (e.g., average electric vehicle and/or the like) to drive a selected distance (e.g., 1 mile, 2 miles, 5 miles, 10 miles, 20 miles, 60 miles, 80 miles, a distance to a nearest charging station, and/or the like).

In some non-limiting embodiments, the charge level of ultra-capacitor array 140 may be maintained within a range that is less than full capacity of ultra-capacitor array 140 and greater than 0 V (e.g., 0 VDC). For example, the charge of ultra-capacitor array 140 may be maintained (e.g., by controller 110, charger 122, and/or the like) within a range of over 120 V, over 240 V, over 480 V, over 600 V, 640-780 V, 755-764 V, and/or the like. In some non-limiting embodiments, if the charge (e.g., voltage) of ultra-capacitor array 140 drops below a threshold, an alert may be generated (e.g., by controller 110) and/or communicated (e.g., from controller 110 to a user device of a user). For example, the threshold may include the bottom of the aforementioned ranges, a selected threshold within such ranges, any combination thereof, and/or the like. In some non-limiting embodiments, the charge of ultra-capacitor array 140 may be maintained (e.g., by controller 110, charger 122, and/or the like) with a voltage much higher than the charging voltage of battery 160, and/or current/voltage controller 152 may reduce the voltage (and/or correspondingly increase the current) of the power supplied from ultra-capacitor array 140 to battery 160 via output 150 (and/or otherwise control the voltage and/or current of the power supplied to battery 160, e.g., based on the maximum rated voltage and/or current of battery 160). For example, higher capacitor voltage may allow for storing more energy and/or using more stored energy from ultra-capacitor array 140 to charge battery 160.

In some non-limiting embodiments, ultra-capacitor array 140 may include a discharge circuit. For example, the discharge circuit may be connected (e.g., electrically connected, coupled, and/or the like) to the ultra-capacitor array 140 array and/or may be configured to discharge energy from the ultra-capacitor array 140 (e.g., when powering down ultra-capacitor array 140, for safety when a cabinet containing ultra-capacitor array 140 is opened, when a failure is detected in the system, and/or the like). In some non-limiting embodiments, the discharge circuit may include a resistor bank, e.g., configured to convert electrical energy into heat, light, any combination thereof, and/or the like. Additionally or alternatively, the discharge circuit may be configured to completely discharge ultra-capacitor array 140 in a predetermined (e.g., selected and/or the like) period of time (e.g., less than 15 minutes, less than 10 minutes, and/or the like). In some non-limiting embodiments, the discharge circuit may be triggered by any powering down event, e.g., a detected error in output 150 (e.g., current/voltage controller 152 thereof), a detected tampering and/or security event, manually powering down, opening a cabinet containing ultra-capacitor array 140, and/or the like. In some non-limiting embodiments, ultra-capacitors of ultra-capacitor array 140 may be shielded from being touched (e.g., at the terminals of each ultra-capacitor, at the terminals of ultra-capacitor array 140, at the terminals of DC bus 130, and/or the like).

Output 150 may include at least one electronic component, at least one circuit, any combination thereof, and/or the like. In some non-limiting embodiments, output 150 may be connected (e.g., electrically connected, coupled, and/or the like) to DC bus 130. Additionally or alternatively, output 150 may be connected (e.g., electrically connected, coupled (e.g., electrically coupled, inductively coupled, and/or the like), and/or the like) to battery 160 (and/or an electric vehicle containing battery 160). In some non-limiting embodiments, output 150 may be configured to receive power, e.g., from DC bus 130 and/or ultra-capacitor array 140. Additionally or alternatively, output 150 may be configured to supply power to battery 160. In some non-limiting embodiments, output 150 may include and/or be connected to current/voltage controller 152. Additionally or alternatively, output 150 (e.g., current/voltage controller 152 thereof and/or the like) may be configured to control (e.g., convert, limit, and/or the like) the current and/or voltage of power being supplied to battery 160. In some non-limiting embodiments, the power outputted from output 150 (e.g., current/voltage controller 152 thereof) may be in a form selected based on the energy needs (e.g., power demands, maximum rated power, maximum rated current, maximum rated voltage, and/or the like) of battery 160. For example, the power outputted from output 150 may have a potential of 120 VAC, 240 VAC, 480 VAC, 690 VAC, and/or the like; a current of 12-16 A, 16-40 A, 30 A, 40 A, 50 A, up to 100 A, greater than 100 A, 120 A, 150 A, 173 A, 175 A, 250 A, and/or the like; and/or a power of 2 kW, 9.6 kW, 10 kW, 50 kW, 60 kW, 100 kW, 120 kW, and/or the like. In some non-limiting embodiments, the power outputted from output 150 may have a potential of 480 V, a current of 120 A, a power of about 58 kW (e.g., 57.6 kW and/or the like), and/or the like. In some non-limiting embodiments, the power outputted from output 150 may have a potential of 480 V, a current of 250 A, a power of 120 kW, and/or the like. In some non-limiting embodiments, the power outputted from output 150 may have at least one of a power, a current, a voltage, any combination thereof, and/or the like based on a user's input to an HMI (e.g., a make of an electric vehicle, a model of an electric vehicle, a year (e.g., model year) of an electric vehicle, a desired power, a desired current, a desired voltage, any combination thereof, and/or the like), as described herein.

In some non-limiting embodiments, output 150 may include current/voltage controller 152. For example, current/voltage controller 152 may include any suitable current controller, e.g., an independent current source, a dependent current source, a constant current (CC) power supply, a constant current constant voltage power supply, a switched mode power supply (SMPS), a current regulator, and/or the like. Additionally or alternatively, current/voltage controller 152 may include any suitable voltage controller, e.g., an independent voltage source, a dependent voltage source, a constant voltage (CV) power supply, a constant current constant voltage power supply, a voltage regulator, a voltage converter, and/or the like. Additionally or alternatively, current/voltage controller 152 may be configured to control (e.g., convert, limit, and/or the like) the current and/or voltage of power being supplied to battery 160.

In some non-limiting embodiments, current/voltage controller 152 may regulate the current of power being supplied to battery 160 via output 150 based on battery management requirements and/or a battery management system associated with battery 160 (e.g., a battery management system of an electric vehicle). Additionally or alternatively, current/voltage controller 152 may regulate the current of power being supplied to battery 160 via output 150 so as not to overcharge battery 160.

In some non-limiting embodiments, output 150 (e.g., current/voltage controller 152 thereof and/or the like) may supply any suitable type of power to battery 160. For example, output 150 (e.g., current/voltage controller 152 thereof and/or the like) may supply DC power, AC power (e.g., single-phase AC power, three phase AC power, and/or the like), and/or the like to battery 160.

In some non-limiting embodiments, output 150 may include (e.g., completely, partially, and/or the like) and/or include a part of an inductive charger for battery 160. For example, output 150 may include at least one first induction coil (e.g., primary coil, transmission coil, and/or the like), which may induce a magnetic field when power (e.g., current, such as AC and/or the like) is supplied thereto (e.g., via current/voltage controller 152 and/or the like, which may be connected to the induction coil(s)). Additionally or alternatively, battery 160 may include and/or have connected thereto at least one second induction coil (e.g., secondary coil, receiving coil, and/or the like). For example, an electric vehicle containing battery 160 may include the second induction coil(s). Additionally or alternatively, the magnetic field from the first induction coil(s) may induce power (e.g., current and/or the like) in the second coil(s). In some non-limiting embodiments, an additional rectifier circuit (e.g., within an electric vehicle, connected to battery 160, and/or the like) may receive the power (e.g., current) from the second induction coil(s) (e.g., by the additional rectifier circuit being connected to the second induction coil(s) and/or the like) and may convert the power into a suitable type (e.g., DC and/or the like) to be supplied to battery 160 (e.g., by the additional rectifier circuit being connected to battery 160 and/or the like).

In some non-limiting embodiments, output 150 may include filter 154. For example, filter 154 may be configured to filter power outputted from current/voltage controller 152 based on the form of power desired (e.g., selected and/or the like) for battery 160. In some non-limiting embodiments, filter 154 may reduce (e.g., decrease, eliminate, and/or the like) a ripple of the power outputted from output 150. For example, the ripple may be eliminated (e.g., ripple-free power) and/or reduced to be within a range (e.g., within a predetermined range, within a suitable range for battery 160 and/or an electric vehicle containing battery 160, less than a threshold, and/or the like). In some non-limiting embodiments, filter 154 may include at least one inductor. For example, filter 154 may include a two-pole inductor and/or the like.

In some non-limiting embodiments, output 150 may include at least one physical connector for connecting to battery 160 and/or an electric vehicle containing battery 160. For example, the physical connector(s) of output 150 may include a J plug (e.g., SAE J1772 connector), which may be the same as or similar to electrical connectors of Level 1 and/or Level 2 chargers. Additionally or alternatively, the physical connector(s) of output 150 may include at least one connector that is the same as or similar to the connectors of Level 3 chargers (e.g., a CHAdeMO connector, a CCS connector, a Tesla connector, and/or the like). In some non-limiting embodiments, output 150 may include at least one adapter, e.g., to allow connection between the physical connector(s) of output 150 and the connector/port of an electric vehicle and/or battery 160. For example, output 150 may have one (or a small number of) physical connector(s) and a plurality of adapters to allow connection (e.g., electrical connection, coupling, and/or the like) between the physical connector(s) and a plurality of connectors/ports of electric vehicles of different types (e.g., different makes, different models, different model years, electric vehicles with J plugs, electric vehicles with Level 3 charger connectors (e.g., CHAdeMO, CCS, and/or Tesla), any combination thereof, and/or the like).

Battery 160 may include any suitable battery or combination of batteries. For example, battery 160 may include at least one battery of an electric vehicle. Additionally or alternatively, battery 160 may include at least one battery that was designed, built, installed, established, and/or the like to serve a particular purpose (e.g., to power a particular item, such as a tool, a facility, and/or the like). In some non-limiting embodiments, battery 160 may be connected (e.g., electrically connected, coupled, and/or the like) to output 150. In some non-limiting embodiments, battery 160 may include a battery having relatively large capacity and/or capability of relatively fast and/or high power charging. For example, battery 160 may include a battery having 40 kWh, 50 kWh, 60 kWh, 62 kWh, 70 kWh, 75 kWh, 85 kWh, 90 kWh, 100 kWh, and/or the like capacity. Additionally or alternatively, battery 160 may have a capability of charging from a Level 1 charger, a Level 2 charger, a Level 3 charger, or with greater current and/or power than Level 3 chargers.

In some non-limiting embodiments, the system (e.g., including ultra-capacitor array 140) may be used to supplement to an existing charger. For example, the system (e.g., including ultra-capacitor array 140) may be connected in series or in parallel with a battery charger having relatively low power (e.g., a Level 1 charger, a Level 2 charger, and/or the like). Additionally or alternatively, the system (e.g., ultra-capacitor array 140) may be used instead of and/or simultaneously with (e.g., boost the power of) the low power charger until the energy stored in the ultra-capacitors is depleted, and/or the system (e.g., ultra-capacitor array 140) may allow the low power charger to finish charging battery 160 at a lower power rate until battery 160 is fully charged.

In some non-limiting embodiments, charger battery 170 may include any suitable battery or combination of batteries. For example, charger battery 170 may include at least one rechargeable battery. Additionally or alternatively, charger battery 170 may include at least one single-use battery. In some non-limiting embodiments, charger battery 170 may include at least one battery that was designed, built, installed, established, and/or the like to charge other batteries, such as battery 160. In some non-limiting embodiments, charger battery 170 may include a battery having relatively large capacity and/or capability of relatively fast and/or high power charging. For example, charger battery 170 may include a battery having 40 kWh, 50 kWh, 60 kWh, 62 kWh, 70 kWh, 75 kWh, 85 kWh, 90 kWh, 100 kWh, and/or the like capacity. Additionally or alternatively, charger battery 170 may have a capability of charging from a Level 1 charger, a Level 2 charger, a Level 3 charger, or with greater current and/or power than Level 3 chargers. In some non-limiting embodiments, charger battery 170 may be connected in parallel to ultra-capacitor array 140. For example, ultra-capacitor array 140 and charger battery 170 may be connected in parallel such that the combined (e.g., summed and/or the like) current of the parallel-connected ultra-capacitor array 140 and charger battery 170 satisfies (e.g., equals, exceeds, and/or the like) the desired current of the system (e.g., output 150, battery 160, and/or the like). In such an example, ultra-capacitor array 140 may be capable of discharging rapidly, while charger battery 170 may discharge steadily (e.g., provide a relatively constant amount of current and/or power) for a relatively longer period of time. For example, ultra-capacitor array 140 may have relatively higher power density and lower energy density, while charger battery 170 may have relatively lower power density and higher energy density. Thus, by including charger battery 170 in parallel with ultra-capacitor array 140, fewer ultra-capacitors may be necessary to achieve the desired current and/or power of the system (e.g., output 150, battery 160, and/or the like).

In some non-limiting embodiments, controller 110 and/or charger 122 may be configured to control charging and discharging of charger battery 170. For example, controller 110 and/or charger 122 may detect when battery 160 is not connected to output 150 and/or may control charger 122 to charge charger battery 170. Additionally or alternatively, controller 110 and/or charger 122 may detect when battery 160 is connected to output 150 and/or may control charger battery 170 to discharge charger battery 170 to thereby charge battery 160. In some non-limiting embodiments, controller 110 and/or charger 122 may control charger 122 to stop supplying power to charger battery 170 when charger battery 170 is fully charged. In some non-limiting embodiments, controller 110 and/or charger 122 may control charger battery 170 to limit the rate (e.g., in terms of current, power, and/or the like) at which charger battery 170 is charged, for example, to ensure that the rate does not exceed a predetermined threshold (e.g., current threshold, power threshold, and/or the like) associated with charger battery 170 (e.g., less than or equal to a current rating of charger battery 170, less than or equal to a power rating of charger battery 170, and/or the like). Additionally or alternatively, controller 110 and/or charger 122 may control charger battery 170 to limit the rate (e.g., in terms of current, power, and/or the like) at which charger battery 170 is discharged, for example, to ensure that the rate does not exceed a predetermined threshold (e.g., current threshold, power threshold, and/or the like) associated with charger battery 170 (e.g., less than or equal to a current rating of charger battery 170, less than or equal to a power rating of charger battery 170, and/or the like).

The number and arrangement of components, devices, and/or systems shown in FIGS. 1A-1C are provided as an example. There may be additional components, devices, and/or systems; fewer components, devices, and/or systems; different components, devices, and/or systems; and/or differently arranged components, devices, and/or systems than those shown in FIGS. 1A-1C. Furthermore, two or more components, devices, and/or systems shown in FIGS. 1A-1C may be implemented within a single component, device, and/or system, or a single component, device, and/or system shown in FIGS. 1A-1C may be implemented as multiple, distributed components, devices, and/or systems. Additionally or alternatively, a set of components (e.g., one or more components), a set of devices (e.g., one or more devices), and/or a set of systems (e.g., one or more systems) of environment 100 may perform one or more functions described as being performed by another set of components, another set of devices, and/or another set of systems of environment 100.

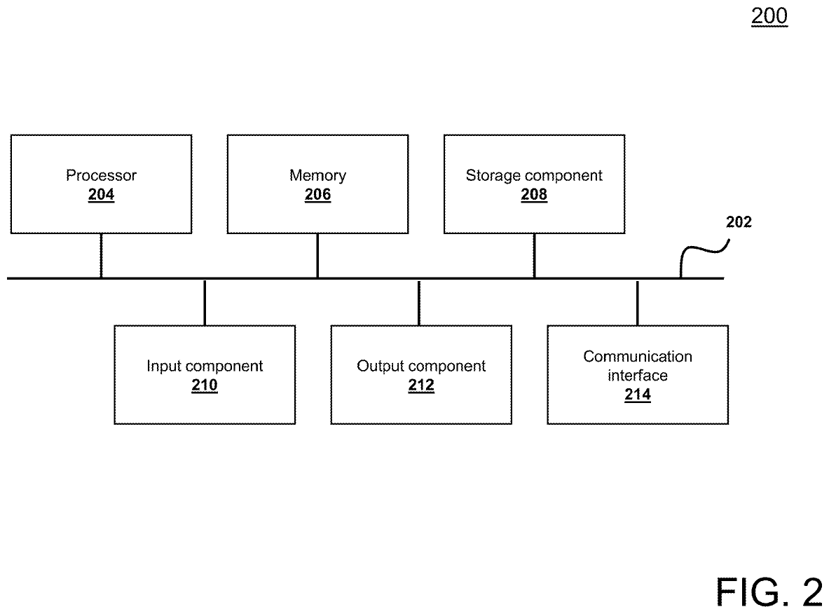

Referring now to FIG. 2, FIG. 2 is a diagram of example components of a device 200. Device 200 may correspond to one or more devices of controller 110, charger 122, current/voltage controller 152, and/or the like. In some non-limiting embodiments, controller 110, charger 122, and/or current/voltage controller 152 may include at least one device 200 and/or at least one component of device 200. As shown in FIG. 2, device 200 may include bus 202, processor 204, memory 206, storage component 208, input component 210, output component 212, and communication interface 214.

Bus 202 may include a component that permits communication among the components of device 200. In some non-limiting embodiments, processor 204 may be implemented in hardware, software, firmware, and/or any combination thereof. For example, processor 204 may include a processor (e.g., a central processing unit (CPU), a graphics processing unit (GPU), an accelerated processing unit (APU), and/or the like), a microprocessor, a digital signal processor (DSP), and/or any processing component (e.g., a field-programmable gate array (FPGA), an application-specific integrated circuit (ASIC), a programmable logic controller (PLC), and/or the like), and/or the like, which can be programmed to perform a function. Memory 206 may include random access memory (RAM), read-only memory (ROM), and/or another type of dynamic or static storage device (e.g., flash memory, magnetic memory, optical memory, and/or the like) that stores information and/or instructions for use by processor 204.

Storage component 208 may store information and/or software related to the operation and use of device 200. For example, storage component 208 may include a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, and/or another type of computer-readable medium, along with a corresponding drive.

Input component 210 may include a component that permits device 200 to receive information, such as via user input (e.g., a touch screen display, a keyboard, a keypad, a mouse, a button, a switch, a microphone, a camera, and/or the like). Additionally or alternatively, input component 210 may include a sensor for sensing information (e.g., a voltmeter, an ammeter, a multimeter, an electric meter, a global positioning system (GPS) component, an accelerometer, a gyroscope, an actuator, and/or the like). Output component 212 may include a component that provides output information from device 200 (e.g., a display, a speaker, one or more light-emitting diodes (LEDs), and/or the like).

Communication interface 214 may include a transceiver-like component (e.g., a transceiver, a receiver and transmitter that are separate, and/or the like) that enables device 200 to communicate with other devices, such as via a wired connection, a wireless connection, or a combination of wired and wireless connections. Communication interface 214 may permit device 200 to receive information from another device and/or provide information to another device. For example, communication interface 214 may include an Ethernet interface, an optical interface, a coaxial interface, an infrared interface, a radio frequency (RF) interface, a universal serial bus (USB) interface, a Wi-Fi® interface, a Bluetooth® interface, a Zigbee® interface, a cellular network interface, and/or the like.

Device 200 may perform one or more processes described herein. Device 200 may perform these processes based on processor 204 executing software instructions stored by a computer-readable medium, such as memory 206 and/or storage component 208. A computer-readable medium (e.g., a non-transitory computer-readable medium) is defined herein as a non-transitory memory device. A non-transitory memory device includes memory space located inside of a single physical storage device or memory space spread across multiple physical storage devices.

Software instructions may be read into memory 206 and/or storage component 208 from another computer-readable medium or from another device via communication interface 214. When executed, software instructions stored in memory 206 and/or storage component 208 may cause processor 204 to perform one or more processes described herein. Additionally or alternatively, hardwired circuitry may be used in place of or in combination with software instructions to perform one or more processes described herein. Thus, embodiments described herein are not limited to any specific combination of hardware circuitry and software.

The number and arrangement of components shown in FIG. 2 are provided as an example. In some non-limiting embodiments, device 200 may include additional components, fewer components, different components, or differently arranged components than those shown in FIG. 2. Additionally or alternatively, a set of components (e.g., one or more components) of device 200 may perform one or more functions described as being performed by another set of components of device 200.

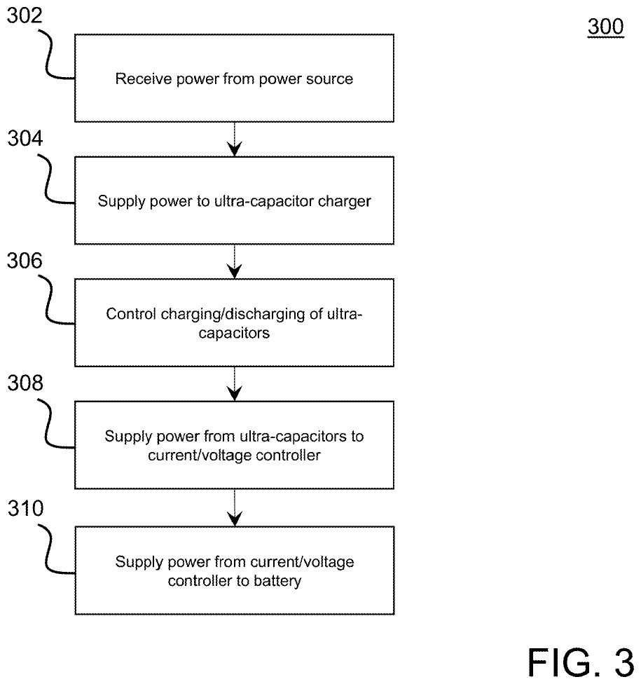

Referring now to FIG. 3, FIG. 3 is a flowchart of a non-limiting embodiment of a process 300 for charging a battery (e.g., of an electric vehicle) using an array of ultra-capacitors. In some non-limiting embodiments, one or more of the steps of process 300 may be performed (e.g., completely, partially, and/or the like) by controller 110 (e.g., one or more devices of controller 110). In some non-limiting embodiments, one or more of the steps of process 300 may be performed (e.g., completely, partially, and/or the like) by another component, another device, another system, another group of components, another group of devices, and/or another group of systems, separate from or including controller 110, such as power source 102, input 120, charger 122, direct current (DC) bus 130, ultra-capacitor array 140, output 150, current/voltage controller 152, battery 160, and/or the like.

As shown in FIG. 3, at step 302, process 300 may include receiving power, as described herein. For example, input 120 may receive power from power source 102. Additionally or alternatively, power source 102 may supply power to input 120.

In some non-limiting embodiments, power source 102 may include at least one of a power grid, a solar panel, a windmill, a power plant, a thermoelectric device, a generator, or any combination thereof.

As shown in FIG. 3, at step 304, process 300 may include supplying power to an ultra-capacitor charger, as described herein. For example, input 120 may supply power to ultra-capacitor charger 122. In some non-limiting embodiments, input 120 and/or ultra-capacitor charger 122 may convert power (e.g., from AC to DC and/or the like), as described herein. Additionally or alternatively, input 120 and/or ultra-capacitor charger 122 may convert power from a first voltage to a second voltage. For example, the second voltage may be higher than the first voltage. In some non-limiting embodiments, input 120 and/or ultra-capacitor charger 122 may filter power using at least one filter (e.g., an RFI filter and/or the like).

As shown in FIG. 3, at step 306, process 300 may include controlling charging and/or discharging of ultra-capacitors, as described herein. For example, input 120 and/or ultra-capacitor charger 122 may supply power to ultra-capacitor array 140 to control charging and/or discharging of ultra-capacitor array 140.

In some non-limiting embodiments, ultra-capacitor array 140 may be connected to DC bus 130. Additionally or alternatively, ultra-capacitor charger 122 may be connected to DC bus 130. Additionally or alternatively, ultra-capacitor charger 122 may be configured to supply power to DC bus 130 to control the charging and/or discharging of ultra-capacitor array 140, as described herein.

In some non-limiting embodiments, at least one controller 110 may be connected to and/or included in ultra-capacitor charger 122. Additionally or alternatively, controller 110 may be configured to control ultra-capacitor charger 122 to control charging and/or discharging of ultra-capacitor array 140, as described herein.

As shown in FIG. 3, at step 308, process 300 may include supplying power from the ultra-capacitors to a current controller, as described herein. For example, ultra-capacitor array 140 may supply power to output 150 and/or current/voltage controller 152.

In some non-limiting embodiments, ultra-capacitor array 140 may be connected to DC bus 130. Additionally or alternatively, output 150 and/or current/voltage controller 152 may be connected to DC bus 130 and/or configured to receive power from DC bus 130 (e.g., power from ultra-capacitor array 140 via DC bus 130 and/or the like).

As shown in FIG. 3, at step 310, process 300 may include supplying power from a current controller to a battery, as described herein. For example, current/voltage controller 152 and/or output 150 may supply power to battery 160.

In some non-limiting embodiments, the system (e.g., including ultra-capacitor array 140) may be used to supplement to an existing charger. For example, the system (e.g., including ultra-capacitor array 140) may be connected in series or in parallel with a battery charger having relatively low power (e.g., a Level 1 charger, a Level 2 charger, and/or the like). Additionally or alternatively, the system (e.g., ultra-capacitor array 140) may be used instead of and/or simultaneously with (e.g., boost the power of) the low power charger until the energy stored in the ultra-capacitors is depleted, and/or the system (e.g., ultra-capacitor array 140) may allow the low power charger to finish charging battery 160 at a lower power rate until battery 160 is fully charged.

In some non-limiting embodiments, current/voltage controller 152 may be configured to control current being supplied to battery 160 (e.g., the current of the power being supplied to battery 160). For example, current/voltage controller 152 may be configured to receive power having a first current from ultra-capacitor array 140 and/or to supply power having a second current to battery 160. In some non-limiting embodiments, the second current may be less than or equal to a current rating of battery 160.

In some non-limiting embodiments, output 150 and/or current/voltage controller 152 may be configured to control voltage being supplied to battery 160 (e.g., the voltage of the power being supplied to battery 160). For example, output 150 may include a voltage converter, and/or the voltage converter may be configured to receive power having a first voltage from the array of ultra-capacitors and to supply power having a second voltage to the at least one battery.

In some non-limiting embodiments, output 150 and/or current/voltage controller 152 may supply any suitable type of power (e.g., DC power, single-phase AC power, three phase AC power, and/or the like) to battery 160, as described herein.

In some non-limiting embodiments output 150 may include (e.g., completely, partially, and/or the like) and/or include a part of an inductive charger for battery 160, as described herein. Additionally or alternatively, output 150 and/or current/voltage controller 152 may supply power to battery 160 via inductive coupling (e.g., at least one first induction coil inducing a magnetic field that induces a current in at least one second induction coil and/or the like), as described herein.

In some non-limiting embodiments, at least one controller 110 may be connected to and/or included in current/voltage controller 152. Additionally or alternatively, controller 110 may be configured to control current/voltage controller 152 to supply power to battery 160, as described herein.

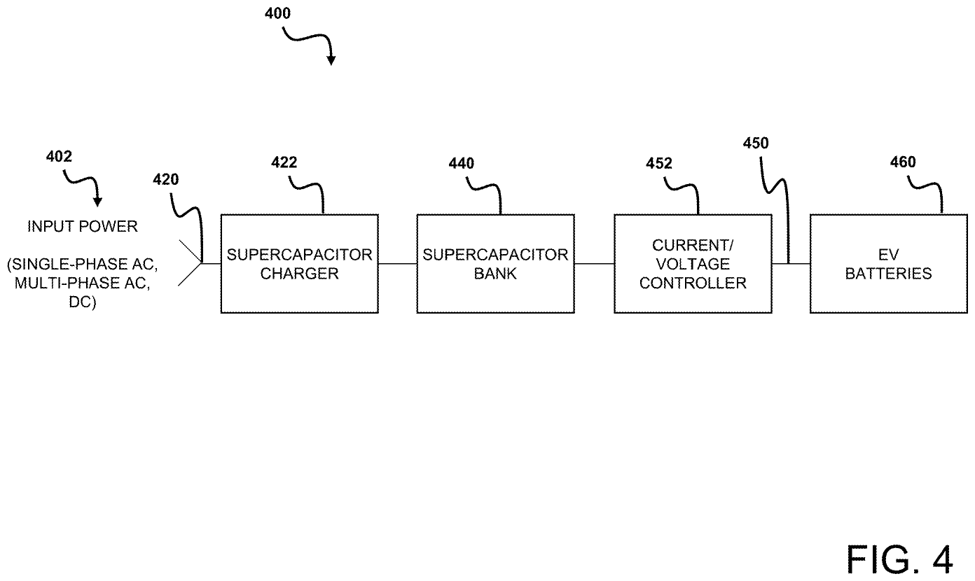

Referring now to FIG. 4, FIG. 4 is a diagram of an exemplary implementation 400 of a non-limiting embodiment relating to process 300 shown in FIG. 3. As shown in FIG. 4, implementation 400 may include power source 402, input 420, ultra-capacitor charger 422, ultra-capacitor array 440, current/voltage controller 452, output 450, battery 460, and/or the like. In some non-limiting embodiments, power source 402 may be the same as or similar to power source 102. In some non-limiting embodiments, input 420 may be the same as or similar to input 120. In some non-limiting embodiments, ultra-capacitor charger 422 may be the same as or similar to ultra-capacitor charger 122. In some non-limiting embodiments, ultra-capacitor array 440 may be the same as or similar to ultra-capacitor array 140. In some non-limiting embodiments, current/voltage controller 452 may be the same as or similar to current/voltage controller 152. In some non-limiting embodiments, output 450 may be the same as or similar to output 150. In some non-limiting embodiments, battery 460 may be the same as or similar to battery 160.

In some non-limiting embodiments, input 420 may be configured to receive power from power source 402, as described herein. Additionally or alternatively, ultra-capacitor charger 422 may be connected to input 420 and/or may be configured to receive power from the input 420, as described herein.

In some non-limiting embodiments, ultra-capacitor charger 422 may be connected to ultra-capacitor array 440, as described herein. For example, ultra-capacitor charger 422 may be connected to a DC bus (e.g., DC bus 130), and the DC bus may be connected to ultra-capacitor array 440. In some non-limiting embodiments, ultra-capacitor charger may be configured to supply power to control charging and/or discharging of ultra-capacitor array 440, as described herein.

In some non-limiting embodiments, current/voltage controller 452 may be configured to receive power from ultra-capacitor array 440, as described herein. For example, current/voltage controller 452 may be connected to a DC bus (e.g., DC bus 130), and the DC bus may be connected to ultra-capacitor array 440. In some non-limiting embodiments, current/voltage controller 452 may be configured to supply power to battery 460 via output 450, as described herein. In some non-limiting embodiments, current/voltage controller 452 may include a filter (e.g., filter 154 and/or the like) connected thereto (e.g., between current/voltage controller 452 and battery 460 and/or the like), as described herein.

Although the disclosed subject matter has been described in detail for the purpose of illustration based on what is currently considered to be the most practical and preferred embodiments, it is to be understood that such detail is solely for that purpose and that the disclosed subject matter is not limited to the disclosed embodiments, but, on the contrary, is intended to cover modifications and equivalent arrangements that are within the spirit and scope of the appended claims. For example, it is to be understood that the presently disclosed subject matter contemplates that, to the extent possible, one or more features of any embodiment can be combined with one or more features of any other embodiment.

What is claimed is:

1. A system, comprising:
an input configured to receive power from a power source;
an array of ultra-capacitors;
an ultra-capacitor charger connected to the input and configured to receive power from the input, the ultra-capacitor charger connected to the array of ultra-capacitors and configured to supply power to control charging and discharging of the array of ultra-capacitors; and
an output connected to the array of ultra-capacitors, the output comprising at least one of a current controller, a voltage controller, or any combination thereof configured to supply power to at least one battery.

2. The system of claim 1, further comprising a direct current (DC) bus,
wherein the array of ultra-capacitors is connected to the DC bus;
wherein the ultra-capacitor charger is connected to the DC bus and configured to supply power to the DC bus to control the charging and discharging of the array of ultra-capacitors; and
wherein the output is connected to the DC bus and configured to receive power from the DC bus.

3. The system of claim 1, further comprising a controller,
wherein the controller is configured to control the ultra-capacitor charger to control charging and discharging of the array of ultra-capacitors, and
wherein the controller is configured to control the at least one of the current controller, the voltage controller, or any combination thereof to supply power to the at least one battery.

4. The system of claim 1, wherein the output further comprises a voltage converter, wherein the voltage converter is configured to receive power having a first voltage from the array of ultra-capacitors and to supply power having a second voltage to the at least one battery.

5. The system of claim 1, wherein the power source comprises at least one of a power grid, a solar panel, a windmill, a power plant, a thermoelectric device, a generator, or any combination thereof.

6. The system of claim 1, wherein the current controller is configured to receive power having a first current from the array of ultra-capacitors and to supply power having a second current to the at least one battery, wherein the second current is less than or equal to a current rating of the at least one battery.

7. The system of claim 1, wherein the power source comprises at least one of a direct current (DC) power source, an alternating current (AC) power source, a single-phase AC power source, a three-phase AC power source, a multi-phase AC power source, or any combination thereof.

8. The system of claim 1, wherein the output is configured to supply at least one of direct current (DC) power, alternating current (AC) power, single-phase AC power, three-phase AC power source, multi-phase AC power, or any combination thereof to the battery.

9. The system of claim 1, further comprising an inductive charger comprising at least one first induction coil connected to the output and at least one second induction coil connected to the battery, wherein the output is configured to supply power via the inductive charger to the at least one battery.

10. A method, comprising:
receiving power at an input from a power source;
supplying power from the input to an ultra-capacitor charger;
supplying power from the ultra-capacitor charger to an array of ultra-capacitors to control charging and discharging of the array of ultra-capacitors;
supplying power from the array of ultra-capacitors to an output comprising at least one of a current controller, a voltage controller, or any combination thereof; and
supplying power from the output to at least one battery.

11. The method of claim 10, wherein a direct current (DC) bus is connected to the ultra-capacitor charger, the array of ultra-capacitors, and the output,
wherein supplying power from the ultra-capacitor charger to the array of ultra-capacitors comprises supplying power from the ultra-capacitor charger to the DC bus to control the charging and discharging of the array of ultra-capacitors, and
wherein supplying power from the array of ultra-capacitors to the output comprises supplying power from the array of ultra-capacitors to the DC bus to supply power to the output.

12. The method of claim 10, wherein the output further comprises a voltage converter, and
wherein supplying power from the output to the at least one battery comprises:
receiving, by the voltage converter, power having a first voltage from the array of ultra-capacitors; and
supplying, by the voltage converter, power having a second voltage to the at least one battery.

13. The method of claim 10, wherein supplying power from the output to the at least one battery comprises:
receiving, by the current controller, power having a first current from the array of ultra-capacitors; and
supplying, by the current controller, power having a second current to the at least one battery, wherein the second current is less than or equal to a current rating of the at least one battery.

14. The method of claim 10, wherein the output comprises at least one first induction coil,
wherein the battery is connected to at least one second induction coil, and
wherein supplying power from the output to the at least one battery comprises supplying power via the at least one first induction coil to the at least one second induction coil to supply power to the at least one battery.

15. A computer program product comprising at least one non-transitory computer-readable medium including one or more instructions that, when executed by at least one processor, cause the at least one processor to:
control an ultra-capacitor charger to receive power from an input connected to a power source and to supply power to control charging and discharging of an array of ultra-capacitors connected to the ultra-capacitor charger; and
control at least one of a current controller, a voltage controller, or any combination thereof to receive power from the array of ultra-capacitors and to supply power via an output to at least one battery.

16. The computer program product of claim 15, wherein a direct current (DC) bus is connected to the ultra-capacitor charger, the array of ultra-capacitors, and the output,
wherein controlling the ultra-capacitor charger comprises controlling the ultra-capacitor charger to supply power to the DC bus to control the charging and discharging of the array of ultra-capacitors, and
wherein controlling the at least one of the current controller, the voltage controller, or any combination thereof comprises controlling the at least one of the current controller, the voltage controller, or any combination thereof to receive power from the array of ultra-capacitors via the DC bus.

17. The computer program product of claim 15, wherein the output further comprises a voltage converter, and
wherein supplying power via the output to the at least one battery comprises controlling the voltage converter to:
receive power having a first voltage from the array of ultra-capacitors; and
supply power having a second voltage to the at least one battery.

18. The computer program product of claim 15, wherein controlling the current controller comprises controlling the current controller to:
receive power having a first current from the array of ultra-capacitors; and
supply power having a second current to the at least one battery, wherein the second current is less than or equal to a current rating of the at least one battery.

19. The computer program product of claim 15, wherein the output comprises at least one first induction coil,
wherein the battery is connected to at least one second induction coil, and
wherein supplying power via the output to the at least one battery comprises supplying power via the at least one first induction coil to the at least one second induction coil to supply power to the at least one battery.
